(19) United States
(12) Patent Application Publication
(10) Pub. No.: US 2026/0307685 A1
(43) Pub. Date: Oct. 8, 2026

(54) JOINT INTENTION AND TRAJECTORY PREDICTION

(71) Applicant: HONDA MOTOR CO., LTD., Tokyo (JP)

(72) Inventors: Erica WENG, San Jose, CA (US); Enna SACHDEVA, Santa Clara, CA (US); Nakul AGARWAL, San Francisco, CA (US); Pero SUBASIC, San Jose, CA (US); Kikuo FUJIMURA, Palo Alto, CA (US); Takeshi KIBAYASHI, Tokyo (JP); Toshiyuki KAJI, Tokyo (JP)

(21) Appl. No.: 19/463,007

(22) Filed: Jan. 28, 2026

Related U.S. Application Data
(60) Provisional application No. 63/782,405, filed on Apr. 2, 2025.

(51) Int. Cl. B60W 60/00; B60W 50/00; G06V 10/774; G06V 20/58

(52) U.S. Cl. CPC B60W 60/00274; B60W 50/0097; G06V 10/774; G06V 20/58; B60W 2050/0028; B60W 2420/403; B60W 2554/4045; B60W 2556/10

(57) ABSTRACT

Joint intention and trajectory prediction may include generating an intention prediction for an agent in an operating environment based on an intention predictor model, a set of bird's-eye view (BEV) features from a set of images associated with the agent, and a set of trajectory histories associated with the agent and one or more other agents, generating a trajectory prediction for the agent based on a trajectory predictor model, the set of BEV features, and the set of trajectory histories, and controlling an actuator to operate a joint intention and trajectory prediction autonomous vehicle (AV) based on the trajectory prediction.

### CROSS-REFERENCE TO RELATED APPLICATIONS

This application claims the benefit of U.S. Provisional Patent Application, Serial No. 63/782405 (Attorney Docket No. H1251049US01) entitled “JOINT INTENTION AND TRAJECTORY PREDICTION FOR AUTONOMOUS DRIVING AT INTERSECTIONS USING MULTI-VIEW CAMERA INPUTS”, filed on April 2, 2025; the entirety of the above-noted application(s) is incorporated by reference herein.

### BACKGROUND

Trajectory prediction is the process of estimating the future path of a moving entity, such as a vehicle or a person, based on its past movement and other relevant information. Trajectory prediction may be an important task in various fields, including autonomous driving, robotics, and human movement analysis. Accurate trajectory prediction may be useful for vehicles to navigate efficiently, especially in dynamic environments with other vehicles, pedestrians, and cyclists, for example.

### BRIEF DESCRIPTION

According to one aspect, a system for joint intention and trajectory prediction may include a memory and a processor. The memory may store one or more instructions. The processor may execute one or more of the instructions stored on the memory to perform generating an intention prediction for an agent in an operating environment based on an intention predictor model, a set of bird's-eye view (BEV) features from a set of images associated with the agent, and a set of trajectory histories associated with the agent and one or more other agents. The processor may perform generating a trajectory prediction for the agent based on a trajectory predictor model, the intention prediction, and the set of trajectory histories.

The system for joint intention and trajectory prediction may include a controller and an actuator. The controller may control the actuator to operate the system for joint intention and trajectory prediction based on the trajectory prediction. The system for joint intention and trajectory prediction may include one or more image capture devices capturing the set of images associated with the agent. The processor may extract the set of BEV features from the set of images captured by the one or more image capture devices. The intention predictor model and the trajectory predictor model may be trained end-to-end, as a single unit, during a training phase. The intention prediction may include a left turn prediction, a right turn prediction, or a going straight prediction. The intention predictor model may be trained based on a classification-based loss function. The trajectory predictor model may be trained based on a regression-based loss function. The processor may generate a high-level intention prediction based on the set of BEV features. The processor may generate the trajectory prediction for the agent based on the trajectory predictor model and the high-level intention prediction.

According to one aspect, a system for joint intention and trajectory prediction may include a memory and a processor. The memory may store one or more instructions. The processor may execute one or more of the instructions stored on the memory to perform generating an intention prediction for an agent in an operating environment based on an intention predictor model, a set of bird's-eye view (BEV) features from a set of images associated with the agent, and a set of trajectory histories associated with the agent and one or more other agents. The processor may perform generating a trajectory prediction for the agent based on a trajectory predictor model, the set of BEV features, and the set of trajectory histories.

The system for joint intention and trajectory prediction may include a controller and an actuator. The controller may control the actuator to operate the system for joint intention and trajectory prediction based on the intention prediction and the trajectory prediction. The system for joint intention and trajectory prediction may include one or more image capture devices capturing the set of images associated with the agent. The processor may extract the set of BEV features from the set of images captured by the one or more image capture devices. The intention predictor model and the trajectory predictor model may be trained end-to-end, as a single unit, during a training phase. The intention prediction may include a left turn prediction, a right turn prediction, or a going straight prediction. The intention predictor model may be trained based on a classification-based loss function. The trajectory predictor model may be trained based on a regression-based loss function. The system for joint intention and trajectory prediction may include a sensor sensing the set of trajectory histories associated with the agent and the one or more other agents.

According to one aspect, a computer-implemented method for joint intention and trajectory prediction may include generating an intention prediction for an agent in an operating environment based on an intention predictor model, a set of bird's-eye view (BEV) features from a set of images associated with the agent, and a set of trajectory histories associated with the agent and one or more other agents, generating a trajectory prediction for the agent based on a trajectory predictor model, the set of BEV features, and the set of trajectory histories, and controlling an actuator to operate a joint intention and trajectory prediction autonomous vehicle (AV) based on the trajectory prediction.

### BRIEF DESCRIPTION OF THE DRAWINGS

FIG. 1 is an exemplary component diagram of a system for joint intention and trajectory prediction, according to one aspect.

FIG. 2 is an exemplary flow diagram of a computer-implemented method for joint intention and trajectory prediction, according to one aspect.

FIG. 3 is an exemplary illustration of an architecture associated with joint intention and trajectory prediction, according to one aspect.

FIG. 4 is an exemplary illustration of an architecture associated with joint intention and trajectory prediction, according to one aspect.

FIG. 5A is an exemplary segment of pseudo-code associated with joint intention and trajectory prediction, according to one aspect.

FIG. 5B is an exemplary illustration of an intersection associated with joint intention and trajectory prediction, according to one aspect.

FIG. 6 is an illustration of an example computing environment where one or more of the provisions set forth herein are implemented, according to one aspect.

FIG. 7 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more "processors"), a "memory", a “storage drive”, a "bus", and one or more programmable input/output (I/O) peripherals.

A "database", as used herein, may refer to a table, a set of tables, and a set of data stores (e.g., disks) and/or methods for accessing and/or manipulating those data stores.

An "operable connection", or a connection by which entities are "operably connected", is one in which signals, physical communications, and/or logical communications may be sent and/or received. An operable connection may include a wireless interface, a physical interface, a data interface, and/or an electrical interface.

A "computer communication", as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term "vehicle" may refer to an electric vehicle (EV) that is powered entirely or partially by one or more electric motors powered by an electric battery. The EV may include battery electric vehicles (BEV) and plug-in hybrid electric vehicles (PHEV). Additionally, the term "vehicle" may refer to an autonomous vehicle and/or self-driving vehicle powered by any form of energy. The autonomous vehicle may or may not carry one or more human occupants.

A "vehicle system", as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

According to one aspect, a goal for joint intention and trajectory prediction may be to leverage intentions of agents to improve trajectory prediction using camera images. For example, high-level intentions may be utilized to provide semantic guidance for the trajectory prediction, thereby providing the benefit and/or advantage of enhancing the accuracy and reliability of trajectory predictions. In other words, using bird's-eye view (BEV) features to generate an intention prediction and guiding the trajectory prediction using the intention prediction provides an improvement to the technical field of trajectory prediction for autonomous vehicles by way of more accurate predictions. Stated yet another way, the intention prediction, such as a left turn prediction, a right turn prediction, or a going straight prediction may be utilized as an indicator for low-level BEV trajectory predictions. In this way, the intention prediction and the trajectory prediction may be jointly predicted in an end-to-end manner.

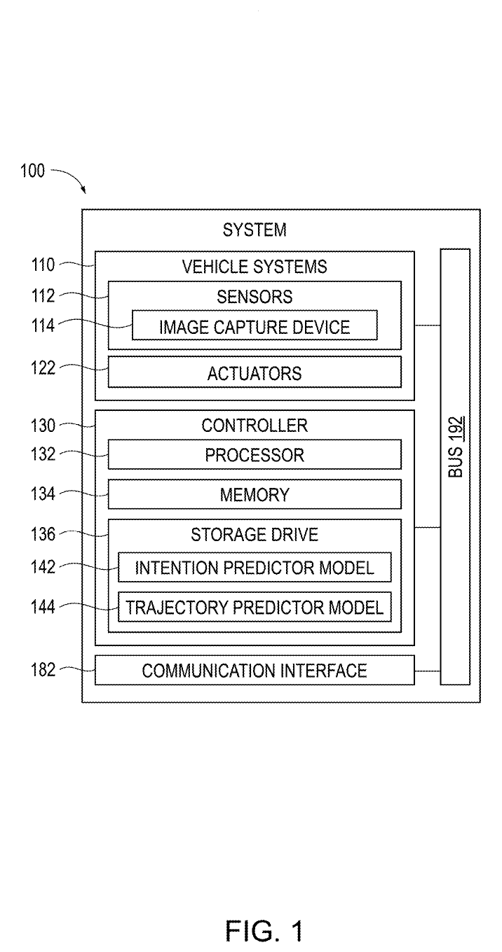

FIG. 1 is an exemplary component diagram of a system 100 for joint intention and trajectory prediction, according to one aspect. The system 100 for joint intention and trajectory prediction may include one or more vehicle systems 110. As discussed herein, one or more of the vehicle systems 110 may include a sensor system or a set of sensors 112. For example, the set of sensors 112 may include an image capture device. Additionally, one or more of the vehicle systems 110 may include one or more actuators 122.

The system 100 for joint intention and trajectory prediction may include a controller 130. The controller 130 may include a processor 132, a memory 134, and a storage drive 136. The storage drive 136 may store one or more models, such as an intention predictor model 142, a trajectory predictor model 144, a feature extractor, etc. The system 100 for joint intention and trajectory prediction may include a communication interface 182 and a bus 192. The bus 192 may form an operable connection between one or more components or sub-components of the system 100 for joint intention and trajectory prediction (e.g., one or more of the vehicle systems 110, the controller 130, the communication interface 182, etc.) and enable computer communication therebetween.

According to one aspect, the intention predictor model 142 and/or the trajectory predictor model 144 may be trained offline or external from the system 100 for joint intention and trajectory prediction and communicated or downloaded to the system 100 for joint intention and trajectory prediction via the communication interface 182 and stored on the storage drive 136. Additionally, the system 100 for joint intention and trajectory prediction may be implemented on an autonomous vehicle (AV), such as a joint intention and trajectory prediction AV.

The image capture device of the set of sensors 112 may include one or more image capture devices 114 or a set of image capture devices and may capture a set of images associated with an agent (e.g., ego-agent or ego-vehicle) within an operating environment through which one or more agents are travelling. For example, the set of images associated with the agent may be taken may cameras mounted on the agent and be images of the operating environment. The processor 132 may extract the set of BEV features from the set of images captured by the one or more image capture devices 114. The BEV features may include, for example, encodings of a spatial context, a road geometry of a roadway within the operating environment, one or more lane markings, one or more road boundaries, one or more obstacles, one or more other agents, etc. This set of BEV features may help the intention predictor model 142 understand a context of a situation and physical feasibility, for example.

Additionally, the processor 132 may generate a high-level intention prediction based on the set of BEV features. These high-level intention predictions or the intention prediction may be indicative of why an agent takes a path, semantics goals, etc.

Additionally, a sensor of the set of sensors 112 may sense a set of trajectory histories associated with the agent and/or one or more other agents within the operating environment. According to one aspect, the sensor may be a light detection and ranging (LiDAR) sensor. The set of trajectory histories for the agent and/or one or more other agents may include x-y coordinates for their respective trajectory histories in a global coordinate frame.

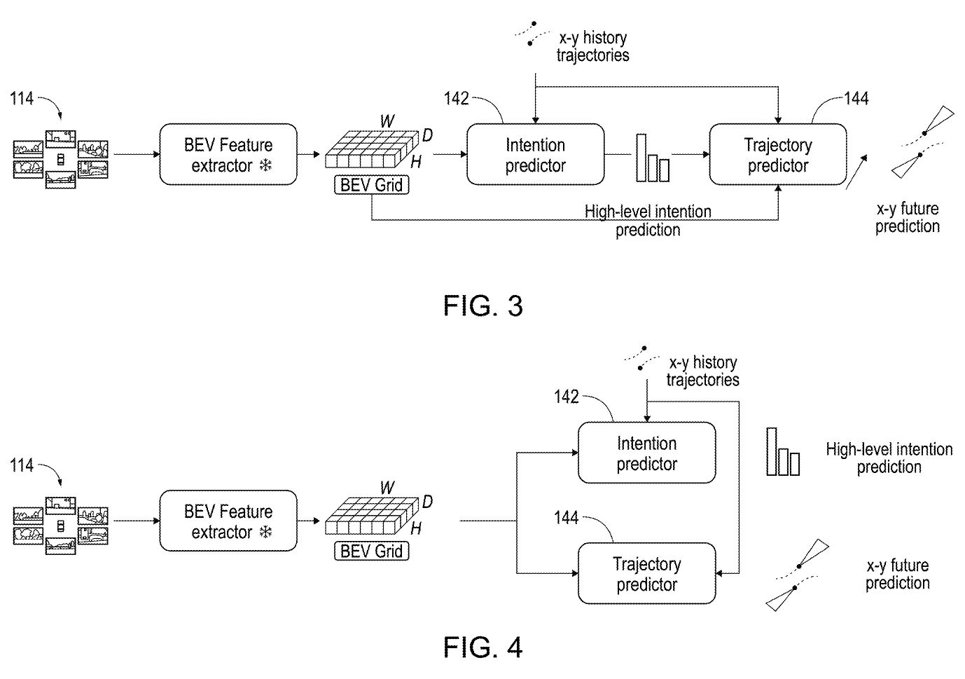

The memory 134 may store one or more instructions. The processor 132 may execute one or more of the instructions stored on the memory 134 to perform one or more acts, actions, and/or steps. According to one aspect, and with reference to FIG. 3, the processor 132 may execute one or more of the instructions stored on the memory 134 to perform generating an intention prediction for an agent in an operating environment based on the intention predictor model 142, a set of bird's-eye view (BEV) features from a set of images associated with the agent, and a set of trajectory histories associated with the agent and one or more other agents. The processor 132 may perform generating a trajectory prediction (e.g., may include x-y coordinates) for the agent based on the trajectory predictor model 144, the intention prediction, and the set of trajectory histories. According to one aspect, the processor 132 may generate the trajectory prediction for the agent based on the trajectory predictor model 144 and the high-level intention prediction. The controller 130 may control the actuators 122 to operate the system 100 for joint intention and trajectory prediction or the joint intention and trajectory prediction AV based on the trajectory prediction. For example, the actuators 122 may cause the joint intention and trajectory prediction AV to move along a route corresponding to the trajectory prediction.

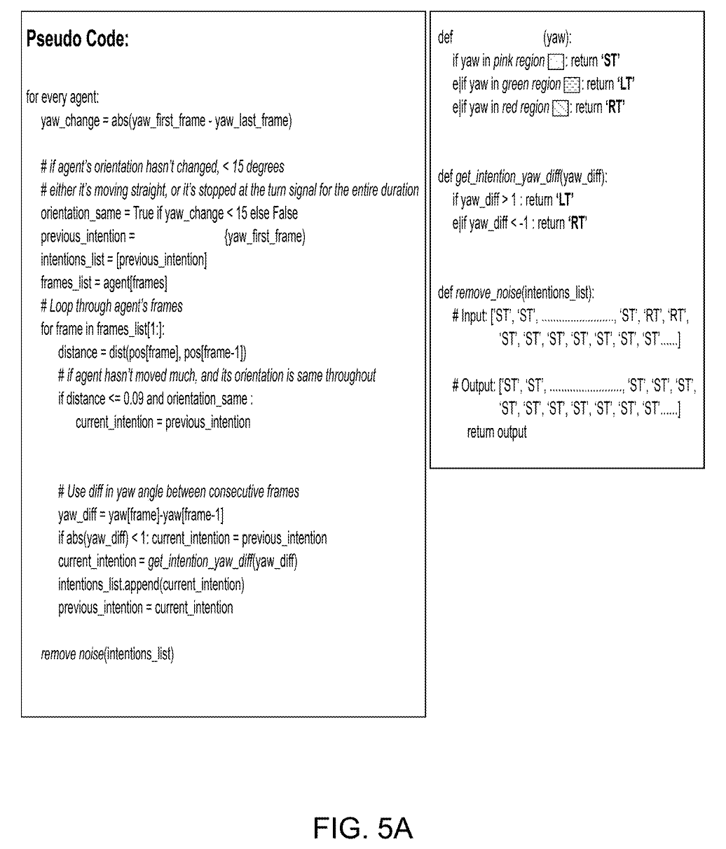

According to another aspect, and with reference to FIG. 4, the processor 132 may execute one or more of the instructions stored on the memory 134 to perform generating the intention prediction for an agent in an operating environment based on the intention predictor model 142, the of BEV features from the set of images associated with the agent, and the set of trajectory histories associated with the agent and one or more other agents. The processor 132 may perform generating the trajectory prediction for the agent based on the trajectory predictor model 144, the set of BEV features, and the set of trajectory histories. The controller 130 may control the actuators 122 to operate the system 100 for joint intention and trajectory prediction or the joint intention and trajectory prediction AV based on the intention prediction and the trajectory prediction. For example, the actuators 122 may cause the joint intention and trajectory prediction AV to move along a route corresponding to the intention prediction and the trajectory prediction.

The intention predictor model 142 and the trajectory predictor model 144 may be trained end-to-end, as a single unit, during a training phase using ground truth data. The ground truth data may be derived using heuristics from a training dataset. The intention prediction may include a left turn prediction, a right turn prediction, or a going straight prediction. The intention predictor model 142 may be trained based on a classification-based loss function. The trajectory predictor model 144 may be trained based on a regression-based loss function.

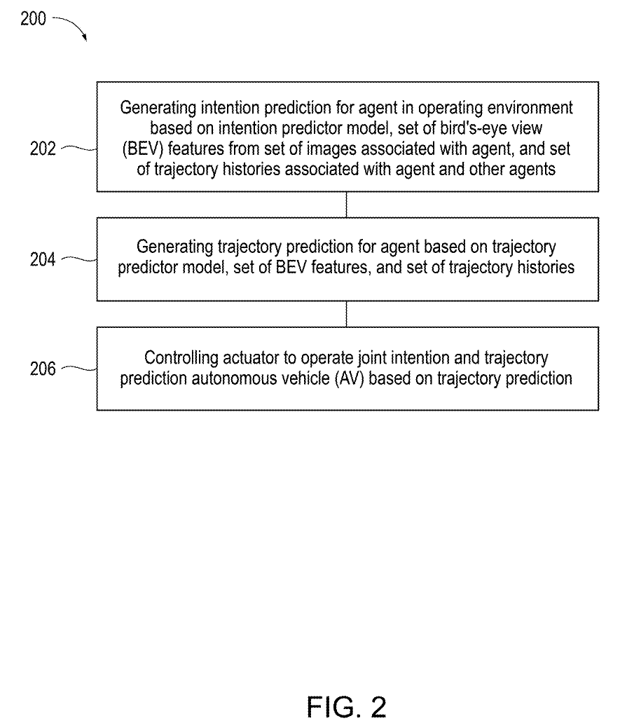

FIG. 2 is an exemplary flow diagram of a computer-implemented method 200 for joint intention and trajectory prediction, according to one aspect. The computer-implemented method 200 for joint intention and trajectory prediction may include generating 202 an intention prediction for an agent in an operating environment based on the intention predictor model 142, a set of bird's-eye view (BEV) features from a set of images associated with the agent, and a set of trajectory histories associated with the agent and one or more other agents, generating 204 a trajectory prediction for the agent based on the trajectory predictor model 144, the set of BEV features, and the set of trajectory histories, and controlling 206 an actuator 122 to operate a joint intention and trajectory prediction autonomous vehicle (AV) based on the trajectory prediction.

FIG. 3 is an exemplary illustration of an architecture associated with joint intention and trajectory prediction, according to one aspect. In FIG. 3, the processor 132 may extract the set of BEV features from the set of images captured by the one or more image capture devices 114, generate the intention prediction for the agent based on the intention predictor model 142, the set of BEV features, and the set of trajectory histories associated with the agent and one or more other agents captured by the sensor. Additionally, the processor 132 may generate the trajectory prediction for the agent based on the trajectory predictor model 144, the intention prediction, the set of trajectory histories, and the high-level intention prediction from the set of BEV features. In this way, the intention prediction may explicitly guide the trajectory prediction.

FIG. 4 is an exemplary illustration of an architecture associated with joint intention and trajectory prediction, according to one aspect. In FIG. 4, the processor 132 may extract the set of BEV features from the set of images captured by the one or more image capture devices 114, generate the intention prediction for the agent based on the intention predictor model 142, the set of BEV features, and the set of trajectory histories. Additionally, the processor 132 may generate the trajectory prediction for the agent based on the trajectory predictor model 144 and the set of trajectory histories. According to the aspect of FIG. 4, the intention prediction does not explicitly guide the trajectory prediction.

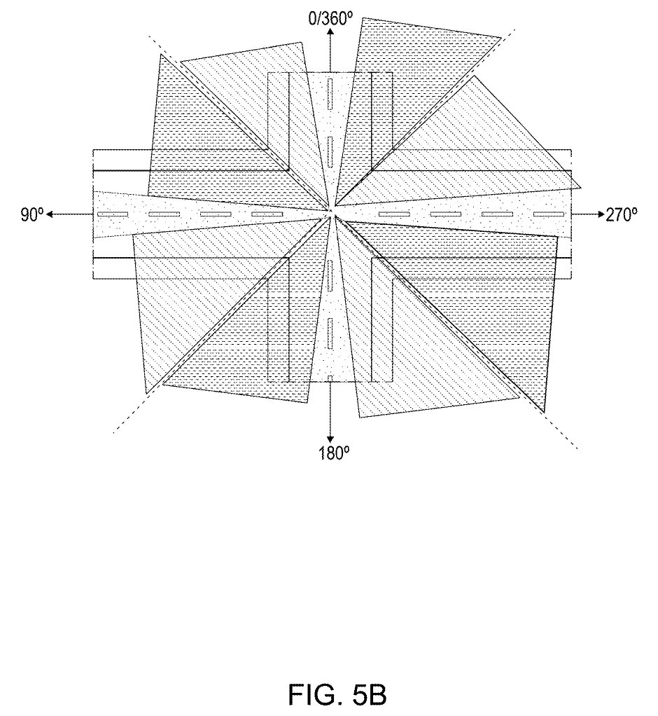

FIG. 5A is an exemplary segment of pseudo-code associated with joint intention and trajectory prediction, according to one aspect. This pseudo-code may include the heuristics for deriving the ground truth data from the training dataset. FIG. 5B is an exemplary illustration of an intersection associated with joint intention and trajectory prediction, according to one aspect.

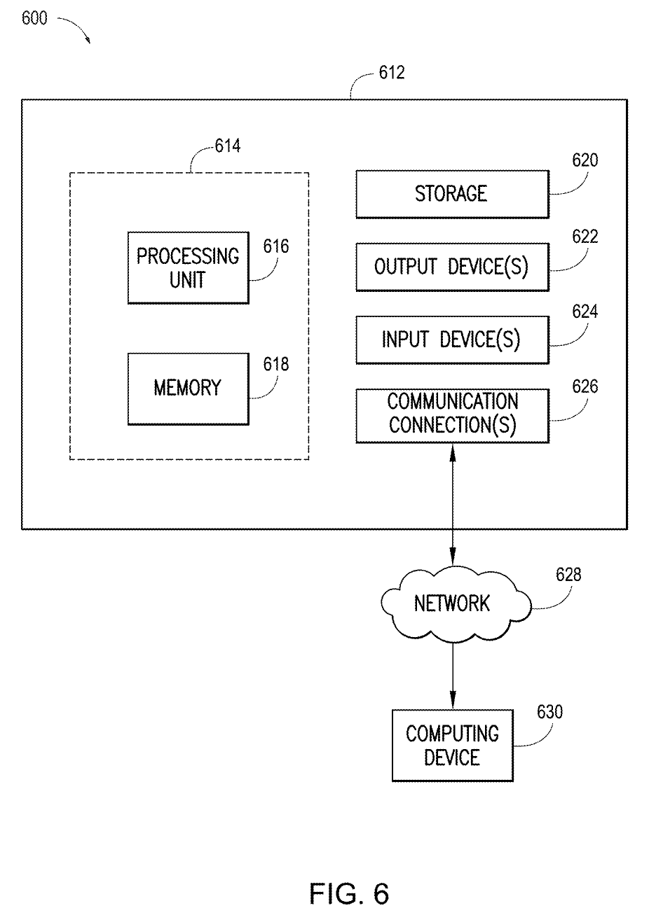

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

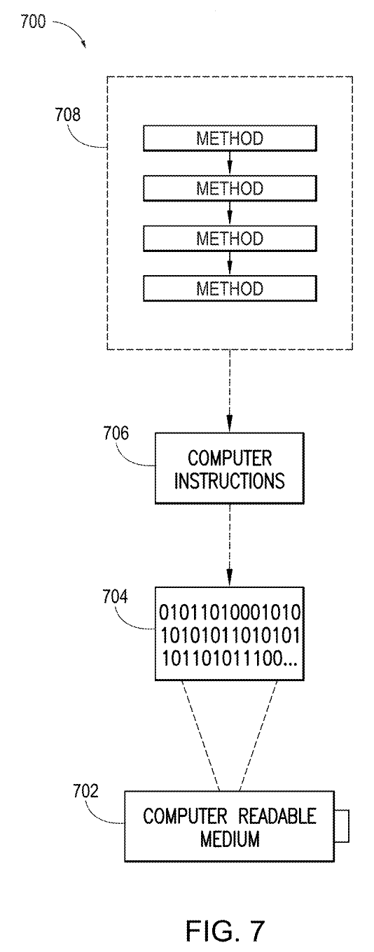

Still another aspect involves a computer-readable medium including processor-executable instructions configured to implement one aspect of the techniques presented herein. An aspect of a computer-readable medium or a computer-readable device devised in these ways is illustrated in FIG. 7, wherein an implementation 700 includes a computer-readable medium 702, such as a CD-R, DVD-R, flash drive, a platter of a hard disk drive, etc., on which is encoded computer-readable data 704. This encoded computer-readable data 704, such as binary data including a plurality of zero’s and one’s as shown in 704, in turn includes a set of processor-executable computer instructions 706 configured to operate according to one or more of the principles set forth herein. In this implementation 700, the processor-executable computer instructions 706 may be configured to perform a method 708, such as the computer-implemented method 200 for joint intention and trajectory prediction of FIG. 2. In another aspect, the processor-executable computer instructions 706 may be configured to implement a system, such as the system 100 for joint intention and trajectory prediction of FIG. 1. Many such computer-readable media may be devised by those of ordinary skill in the art that are configured to operate in accordance with the techniques presented herein.

As used in this application, the terms "component”, "module," "system", "interface", and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, "or" is intended to mean an inclusive "or" rather than an exclusive "or". Further, an inclusive “or” may include any combination thereof (e.g., A, B, or any combination thereof). In addition, "a" and "an" as used in this application are generally construed to mean "one or more" unless specified otherwise or clear from context to be directed to a singular form. Additionally, at least one of A and B and/or the like generally means A or B or both A and B. Further, to the extent that "includes", "having", "has", "with", or variants thereof are used in either the detailed description or the claims, such terms are intended to be inclusive in a manner similar to the term "comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for joint intention and trajectory prediction, comprising:
a memory storing one or more instructions; and
a processor executing one or more of the instructions stored on the memory to perform:
generating an intention prediction for an agent in an operating environment based on an intention predictor model, a set of bird's-eye view (BEV) features from a set of images associated with the agent, and a set of trajectory histories associated with the agent and one or more other agents; and
generating a trajectory prediction for the agent based on a trajectory predictor model, the intention prediction, and the set of trajectory histories.

2. The system for joint intention and trajectory prediction of claim 1, comprising a controller and an actuator, wherein the controller controls the actuator to operate the system for joint intention and trajectory prediction based on the trajectory prediction.

3. The system for joint intention and trajectory prediction of claim 1, comprising one or more image capture devices capturing the set of images associated with the agent.

4. The system for joint intention and trajectory prediction of claim 3, wherein the processor extracts the set of BEV features from the set of images captured by the one or more image capture devices.

5. The system for joint intention and trajectory prediction of claim 1, wherein the intention predictor model and the trajectory predictor model are trained end-to-end, as a single unit, during a training phase.

6. The system for joint intention and trajectory prediction of claim 1, wherein the intention prediction includes a left turn prediction, a right turn prediction, or a going straight prediction.

7. The system for joint intention and trajectory prediction of claim 1, wherein the intention predictor model is trained based on a classification-based loss function.

8. The system for joint intention and trajectory prediction of claim 1, wherein the trajectory predictor model is trained based on a regression-based loss function.

9. The system for joint intention and trajectory prediction of claim 1, wherein the processor generates a high-level intention prediction based on the set of BEV features.

10. The system for joint intention and trajectory prediction of claim 9, wherein the processor generates the trajectory prediction for the agent based on the trajectory predictor model and the high-level intention prediction.

11. A system for joint intention and trajectory prediction, comprising:
a memory storing one or more instructions; and
a processor executing one or more of the instructions stored on the memory to perform:
generating an intention prediction for an agent in an operating environment based on an intention predictor model, a set of bird's-eye view (BEV) features from a set of images associated with the agent, and a set of trajectory histories associated with the agent and one or more other agents; and
generating a trajectory prediction for the agent based on a trajectory predictor model, the set of BEV features, and the set of trajectory histories.

12. The system for joint intention and trajectory prediction of claim 11, comprising a controller and an actuator, wherein the controller controls the actuator to operate the system for joint intention and trajectory prediction based on the intention prediction and the trajectory prediction.

13. The system for joint intention and trajectory prediction of claim 11, comprising one or more image capture devices capturing the set of images associated with the agent.

14. The system for joint intention and trajectory prediction of claim 13, wherein the processor extracts the set of BEV features from the set of images captured by the one or more image capture devices.

15. The system for joint intention and trajectory prediction of claim 11, wherein the intention predictor model and the trajectory predictor model are trained end-to-end, as a single unit, during a training phase.

16. The system for joint intention and trajectory prediction of claim 11, wherein the intention prediction includes a left turn prediction, a right turn prediction, or a going straight prediction.

17. The system for joint intention and trajectory prediction of claim 11, wherein the intention predictor model is trained based on a classification-based loss function.

18. The system for joint intention and trajectory prediction of claim 11, wherein the trajectory predictor model is trained based on a regression-based loss function.

19. The system for joint intention and trajectory prediction of claim 11, comprising a sensor sensing the set of trajectory histories associated with the agent and the one or more other agents.

20. A computer-implemented method for joint intention and trajectory prediction, comprising:
generating an intention prediction for an agent in an operating environment based on an intention predictor model, a set of bird's-eye view (BEV) features from a set of images associated with the agent, and a set of trajectory histories associated with the agent and one or more other agents;
generating a trajectory prediction for the agent based on a trajectory predictor model, the set of BEV features, and the set of trajectory histories; and
controlling an actuator to operate a joint intention and trajectory prediction autonomous vehicle (AV) based on the trajectory prediction.
